(19) United States
(12) Patent Application Publication
(10) Pub. No.: US 2022/0327016 A1
(43) Pub. Date: Oct. 13, 2022

(54) METHOD, ELECTRONIC DEVICE AND PROGRAM PRODUCT FOR DETERMINING THE SCORE OF LOG FILE

(71) Applicant: EMC IP Holding Company LLC, Hopkinton, MA (US)

(72) Inventors: Yongbing Xue, Shanghai (CN); Min Liu, Shanghai (CN); Weiyang Liu, Shanghai (CN); Yudai Wang, Shanghai (CN); Sanping Li, Beijing (CN)

(21) Appl. No.: 17/410,098

(22) Filed: Aug. 24, 2021

(30) Foreign Application Priority Data
Apr. 9, 2021 (CN) 2021103879434

(51) Int. Cl. G06F 11/07; G06F 11/30; G06F 40/20

(52) U.S. Cl. CPC G06F 11/0775; G06F 11/0787; G06F 11/3072; G06F 40/20; G06F 2201/835

(57) ABSTRACT

A method, an electronic device, and a program product for determining a score of a log file are provided. The method includes acquiring a log file related to a monitored system and source code corresponding to the log file. The method may further include determining a first score of the log file based on a first log rule subset in a log rule set, the log rule set being used to evaluate at least one of analyzability of the log file and supportability of the monitored system. The method may further include determining a second score of the source code based on a second log rule subset in the log rule set and determining a third score of the log file at least based on the first score and the second score.

### CROSS REFERENCE TO RELATED APPLICATIONS

This application claims priority under 35 U.S.C. § 119 to Chinese Patent Application No. 2021103879434, filed on Apr. 9, 2021. The contents of Chinese Patent Application No. 2021103879434 are incorporated by reference in its entirety.

### TECHNICAL FIELD

Embodiments of the present disclosure relate to the field of computers, and more particularly, to a method, an electronic device, and a program product for determining a score of a log file.

### BACKGROUND

Network devices, systems, and service programs all generate event records during operation, and these event records may be stored as log files according to log entries (for example, in a form of lines). Each log entry may record operation-related description information such as date, time, user, and action. These log files may generally be used to train a related model to achieve a specific function. However, product development teams usually adopt different forms in writing logs, and therefore, availability of log files varies greatly, thus affecting subsequent operations such as model training.

### SUMMARY OF THE INVENTION

A solution for determining a score of a log file is provided in the present disclosure.

In one aspect of the present disclosure, a method for determining a score of a log file is provided. The method may include acquiring a log file related to a monitored system and source code corresponding to the log file. The method may further include determining a first score of the log file based on a first log rule subset in a log rule set, wherein the log rule set is used to evaluate at least one of analyzability of the log file and supportability of the monitored system. The method may further include determining a second score of the source code based on a second log rule subset in the log rule set. Moreover, the method may include determining a third score of the log file at least based on the first score and the second score.

In another aspect of the present disclosure, an electronic device is provided, including a processor; and a memory coupled to the processor and having instructions stored therein, wherein the instructions, when executed by the processor, cause the electronic device to perform actions including: acquiring a log file related to a monitored system and source code corresponding to the log file; determining a first score of the log file based on a first log rule subset in a log rule set, wherein the log rule set is used to evaluate at least one of analyzability of the log file and supportability of the monitored system; determining a second score of the source code based on a second log rule subset in the log rule set; and determining a third score of the log file at least based on the first score and the second score.

In another aspect of the present disclosure, a computer program product is provided. The computer program product is tangibly stored on a computer-readable medium and includes machine-executable instructions. The machine-executable instructions, when executed, cause a machine to perform any steps of the method according to the first aspect.

The Summary of the Invention section is provided to introduce the selection of concepts in a simplified form, which will be further described in the Detailed Description below. The Summary of the Invention section is neither intended to identify key features or main features of the present disclosure, nor intended to limit the scope of the present disclosure.

### BRIEF DESCRIPTION OF THE DRAWINGS

The above and other objectives, features, and advantages of the present disclosure will become more apparent by describing the example embodiments of the present disclosure in more detail with reference to the accompanying drawings. In the example embodiments of the present disclosure, the same or similar reference numerals generally represent the same or similar parts. In the accompanying drawings,

FIG. 1A is a schematic diagram of an example environment according to one or more embodiments of the present disclosure;

FIG. 1B is a schematic diagram of a table of a log rule set according to one or more embodiments of the present disclosure;

FIG. 2 is a flowchart of a process of processing log entries according to one or more embodiments of the present disclosure;

FIG. 3 is a flowchart of a process of determining a first score according to one or more embodiments of the present disclosure;

FIG. 4 is a flowchart of a process of determining a second score according to one or more embodiments of the present disclosure;

FIG. 5 is a schematic diagram of another example environment according to one or more embodiments of the present disclosure; and

FIG. 6 is a block diagram of an example device that can be configured to implement to one or more embodiments of the present disclosure.

### DETAILED DESCRIPTION

The principles of the present disclosure will be described below with reference to some example embodiments shown in the accompanying drawings.

As used herein, the term “include” and variations thereof mean open-ended inclusion, that is, “including but not limited to.” Unless specifically stated, the term “or” means “and/or.” The term “based on” means “based at least in part on.” The terms “an example embodiment” and “an embodiment” indicate “a group of example embodiments.” The term “another embodiment” indicates “a group of additional embodiments.” The terms “first,” “second,” and the like may refer to different or identical objects. Other explicit and implicit definitions may also be included below.

As discussed above, when a model is used to efficiently analyze log files or log entries, a large number of log files need to be used as a training data set to train the model. However, due to different writing formats of the log files, a considerable part of the log files is of little use value. If a log file is directly used in an operation such as model training without any identification or evaluation, there may be a problem that the operation cannot meet predetermined requirements.

In order to address, at least in part, the above disadvantages, a solution for scoring a log file is provided in the embodiments of the present disclosure. This solution can score a log file (which contains log entries, for example, a line of log in the log file that may correspond to an event record) in a system, and can score source code corresponding to the log file. The two scoring operations may adopt different log rules. For example, a log rule set may be created in advance. The scoring operation on the log file may be performed based on a first log rule subset in the log rule set, and the scoring operation on the source code corresponding to the log file may be performed based on a second log rule subset in the log rule set. A third score of the log file may be determined at least based on a first score and a second score (which may even include other scores, such as a manual score).

This solution can acquire a maturity or usability score of each log file, and further, can use this score as a basis to use log entries whose scores meet predetermined requirements for subsequent processing such as model training. The processing may also include, for example, storage and retrieval, and additionally or alternatively, also include analysis processing of content recorded in the log entries to facilitate subsequent processing.

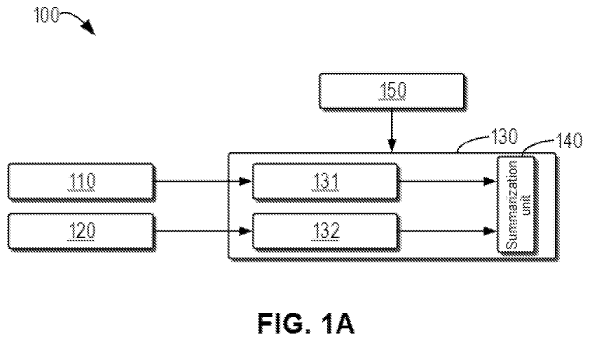

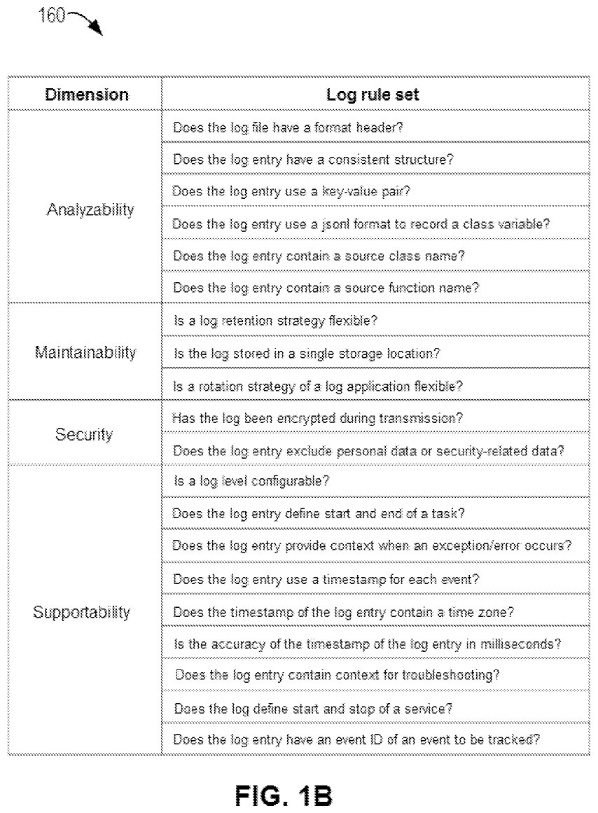

FIG. 1A is a schematic diagram of example environment 100 according to one or more embodiments of the present disclosure. In the example environment 100, a device and/or a process according to one or more embodiments of the present disclosure may be implemented. As shown in FIG. 1, example environment 100 may include log file acquisition unit 110 and source code acquisition unit 120. Log file acquisition unit 110 is configured to acquire a log file from a monitored system, and source code acquisition unit 120 is configured to acquire source code corresponding to the log file from the monitored system. As shown in the drawing, the log file acquired by log file acquisition unit 110 and the source code acquired by source code acquisition unit 120 are both sent to computing device 130.

In some embodiments, computing device 130 may include dynamic analysis unit 131 and static analysis unit 132. The log file acquired by log file acquisition unit 110 and the source code acquired by source code acquisition unit 120 may be input to dynamic analysis unit 131 and static analysis unit 132, respectively. It should be understood that dynamic analysis unit 131 is configured to analyze a log file dynamically generated by the monitored system and determine a score, and static analysis unit 132 is configured to analyze static code of the monitored system and determine a score.

As shown in FIG. 1A, the example environment further includes log rule set 150. Log rule set 150 is pre-configured and input to computing device 130. Hereinafter, an example configuration of log rule set 150 will be described in detail with reference to FIG. 1B. In some embodiments, in a process that dynamic analysis unit 131 in computing device 130 scores the log file dynamically generated by the monitored system, dynamic analysis unit 131 may acquire at least a first log rule subset from log rule set 150, and determine a first score of the log file based on the acquired first log rule subset. As a parallel or sequential execution, in a process that static analysis unit 132 in computing device 130 scores the static source code in the monitored system, static analysis unit 131 may acquire at least a second log rule subset from log rule set 150, and determine a second score of the source code based on the acquired second log rule subset.

After that, the determined first score and second score are input to summarization unit 140. Correspondingly, summarization unit 140 may determine a third score, that is, a comprehensive score of the log file based on the first score and the second score.

It should be understood that although FIG. 1A shows to one or more embodiments in which dynamic analysis unit 131 and static analysis unit 132 are both arranged in computing device 130, alternatively or additionally, other units such as log file acquisition unit 110, source code acquisition unit 120, and summarization unit 140 are also arranged in computing device 130.

The computing device may be any device with a computing capability. As a non-limiting example, the computing device may be any type of fixed computing device, mobile computing device, or portable computing device, including but not limited to a desktop computer, a laptop computer, a notebook computer, a netbook computer, a tablet computer, a smart phone, and the like. All or part of components of the computing device may be distributed in cloud. The computing device may also adopt a cloud-edge architecture.

A storage apparatus (not shown) includes (a plurality of) storage disk(s) for storing data. The storage disks may be various types of devices with a storage function, including but not limited to a hard disk drive (HDD), a solid state disk (SSD), a removable disk, any other magnetic storage device and any other optical storage device, or any combination thereof. The computing device may be configured to store data such as a group of log entries 110 in the storage apparatus in an indexable manner.

In some embodiments, example environment 100 may also include a model to be trained and a model training apparatus (not shown). As an example, the model training apparatus may use scored and filtered log files to train, for example, a natural language processing model. In the description of the embodiment of the present disclosure, the term “model” may learn correlations between corresponding inputs and outputs from training data, so that a given input is processed based on a parameter set obtained by the training after the training is completed, so as to generate a corresponding output. The “model” may sometimes be referred to as a “neural network,” a “learning model,” a “learning network,” or a “network.” These terms are used interchangeably herein.

In the model training apparatus, a training data acquisition apparatus may acquire scored and filtered log files as input data and provide them to the model. The input data may be one of a training set, a validation set, and a test set. Herein, each sample in the input data may be a text recorded by one or more log entries. The model training apparatus may train the model based on the input data. In a model training stage, parameters (e.g., weight and bias) of the model may be adjusted based on at least one constraint (sometimes referred to as loss), and the constraint may represent a performance index (e.g., accuracy) of the model. The training process may adjust the parameters of the model so that at least one constraint moves in a decreasing direction.

It should be understood that the architecture and functions of example environment 100 are described for illustrative purposes only, and do not imply any limitation to the scope of the present disclosure. The embodiments of the present disclosure may also be applied to other environments having different structures and/or functions.

Log rule set 150 will be described in detail below with reference to FIG. 1B.

FIG. 1B shows table 160 of log rule set 150 according to one or more embodiments of the present disclosure. As shown in FIG. 1B, table 160 contains rules for grading maturity of a log file or log entry (sometimes collectively referred to as a log in the present embodiment). As an example, the maturity may be scored based on rules in four dimensions. The four dimensions include, for example, analyzability (for example, analyzability of a text recorded in the log and/or a format recorded in the log, and ability to locate a cause of a defect or failure to indicate the difficulty of extracting useful information from the log), maintainability (for example, repairability of the defect or failure or improvability of existing functions to indicate the difficulty of maintaining the log on a production system), security (for example, indicating whether sensitive data is stored in the log), and supportability (for example, compatibility and extensibility) of the log shown in table 160. The log maturity may indicate the degree of standardization of a log, and a standardized log is the basis for subsequent processing.

In some embodiments, computing device 130 may evaluate, based on any rule in log rule set 150, the log file to be analyzed or its corresponding source code. As an example, dynamic analysis unit 131 configured in computing device 130 may score the log file based on the first log rule subset in log rule set 150. For example, the first log rule subset may include “Does the log file have a format header?”, “Does the log entry have a consistent structure?”, “Does the log entry contain a source class name?”, “Does the log entry contain a source function name?”, “Does the log entry exclude personal data or security-related data?”, “Does the log entry use a timestamp for each event?”, “Does the timestamp of the log entry contain a time zone?”, “Is the accuracy of the timestamp of the log entry in milliseconds?”, “Does the log entry contain context for troubleshooting?”, “Does the log define start and stop of a service?”, “Does the log entry have an event ID of an event to be tracked?”, and other log rules.

As an example, static analysis unit 132 configured in computing device 130 may score the log file based on the second log rule subset in log rule set 150. For example, the second log rule subset may include “Does the log entry use a key-value pair?”, “Does the log entry use a jsonl format to record a class variable?”, “Does the log entry define start and end of a task?”, “Does the log entry provide context when an exception/error occurs?”, and other log rules.

As another example, a staff may also score text information. For example, the second log rule subset may include “Is a log retention strategy flexible?”, “Is the log stored in a single storage location?”, “Is a rotation strategy of a log application flexible?”, “Has the log been encrypted during transmission?”, “Is a log level configurable?”, and other log rules. It should be understood that in addition to scoring manually, text information may further be scored based on a machine learning model.

It is understandable that although only the method of scoring by rules in four dimensions for maturity rating is shown, rules in more or fewer dimensions may further be set as needed. In addition, each dimension may be divided into three levels according to two score thresholds, but more score thresholds may be set to be divided into more levels as needed, or different score thresholds may be set. The present disclosure is not limited thereto.

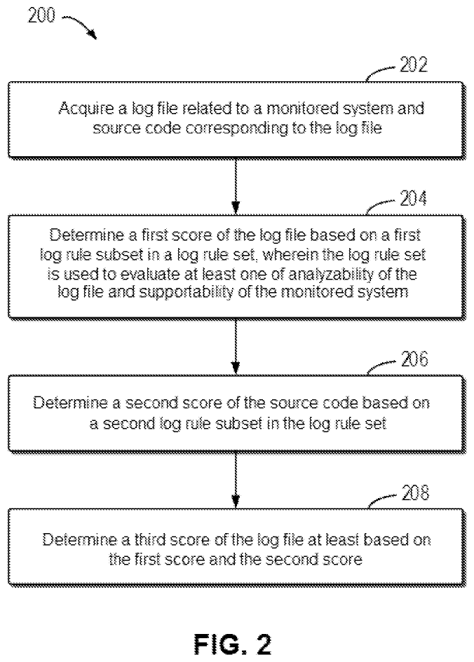

A process according to one or more embodiments of the present disclosure will be described in detail below with reference to FIG. 2 to FIG. 4. For ease of understanding, specific data mentioned in the following description is illustrative and is not intended to limit the protection scope of the present disclosure. It should be understood that embodiments described below may also include additional actions not shown and/or may omit actions shown, and the scope of the present disclosure is not limited in this regard.

FIG. 2 is a flowchart of process 200 of processing log entries according to one or more embodiments of the present disclosure. In some embodiments, process 200 may be implemented in computing device 130 in FIG. 1A. Process 200 for failure analysis according to one or more embodiments of the present disclosure is described now with reference to FIG. 1A. For ease of understanding, specific examples mentioned in the following description are illustrative and are not intended to limit the protection scope of the present disclosure.

As shown in FIG. 2, in 202, computing device 130 may acquire a log file related to a monitored system and source code corresponding to the log file. In some embodiments, computing device 130 may acquire the log file related to the monitored system from log file acquisition unit 110, and computing device 130 may acquire the source code corresponding to the log file from source code acquisition unit 120. It should be understood that each log entry in the log file or source code may include multiple fields, and each field stores fixed information. Examples of the fields include, but are not limited to, a time information field, a machine information field, a path information field, a custom information field, and the like. In some embodiments, the time information field may include at least one of the following: a date field, a time field, a timestamp field, and a year field; the machine information field may include at least one of the following: a fully qualified domain name (FQDN) field, a domain name field, an IP address field, and a MAC address field; the path information field may include at least one of the following: a URL/URI field and a system path field such as Windows; and the custom information field may include at least one of the following: a process ID field, a thread ID field, and a job ID field. Corresponding information may be recorded in each field, for example, in the form of text.

In 204, computing device 130 may determine a first score of the log file based on a first log rule subset in log rule set 150. The log rule set is used to evaluate at least one of analyzability of the log file and supportability of the monitored system. In some embodiments, the log rule set is used to evaluate at least one of the analyzability, maintainability, security, and supportability of the log file.

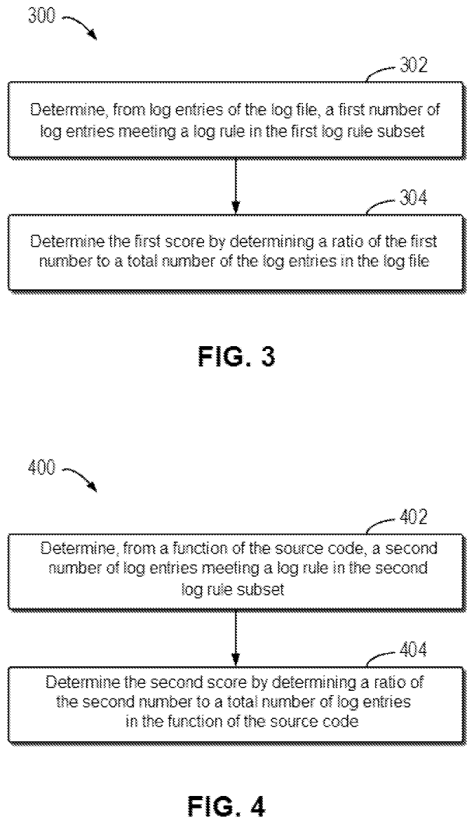

In some embodiments, in order to determine the first score, computing device 130 may score log entries in the acquired log file. FIG. 3 is a flowchart of process 300 of determining a first score according to one or more embodiments of the present disclosure. In some embodiments, process 300 may be implemented in computing device 130 in FIG. 1A. Process 300 of determining the first score according to one or more embodiments of the present disclosure will now be described with reference to FIG. 1A. For ease of understanding, specific examples mentioned in the following description are illustrative and are not intended to limit the protection scope of the present disclosure.

As shown in FIG. 3, in 302, computing device 130 may determine, from the log entries of the log file, a first number of log entries meeting a log rule in the first log rule subset. In some embodiments, dynamic analysis unit 131 configured in computing device 130 may perform determination on the log file based on the first log rule subset in log rule set 150. For example, the first log rule subset may include “Does the log file have a format header?”, “Does the log entry have a consistent structure?”, “Does the log entry contain a source class name?”, “Does the log entry contain a source function name?”, “Does the log entry exclude personal data or security-related data?”, “Does the log entry use a timestamp for each event?”, “Does the timestamp of the log entry contain a time zone?”, “Is the accuracy of the timestamp of the log entry in milliseconds?”, “Does the log entry contain context for troubleshooting?”, “Does the log define start and stop of a service?”, “Does the log entry have an event ID of an event to be tracked?”, and other log rules. For each log rule, dynamic analysis unit 131 may determine whether each log entry meets the log rule one by one, so that the number of log entries meeting a log rule in the log file, that is, first data, can be determined.

As an example, computing device 130 may extract timestamps of the log entries in the log file, and determine the number of a group of timestamps meeting a predetermined time accuracy requirement (i.e., “Is the accuracy of the timestamp of the log entry in milliseconds?”) among the extracted timestamps as the first number.

In 304, computing device 130 may determine the first score by determining a ratio of the first number to a total number of the log entries in the log file. In this way, scoring information of the log file can be acquired.

After that, returning to FIG. 2, in 206, computing device 130 may determine a second score of the source code based on a second log rule subset in log rule set 150.

In some embodiments, in order to determine the second score, computing device 130 may score log entries in the acquired source code. FIG. 4 is a flowchart of process 400 of determining a second score according to one or more embodiments of the present disclosure. In some embodiments, process 400 may be implemented in computing device 130 in FIG. 1A. Process 400 of determining the second score according to one or more embodiments of the present disclosure will now be described with reference to FIG. 1A. For ease of understanding, specific examples mentioned in the following description are illustrative and are not intended to limit the protection scope of the present disclosure.

As shown in FIG. 4, in 402, computing device 130 may determine, from a function of the source code, a second number of log entries meeting a log rule in the second log rule subset. In some embodiments, static analysis unit 132 configured in computing device 130 may perform determination on the source code based on the second log rule subset in log rule set 150. For example, the second log rule subset may include “Does the log entry use a key-value pair?”, “Does the log entry use a jsonl format to record a class variable?”, “Does the log entry define start and end of a task?”, “Does the log entry provide context when an exception/error occurs?”, and other log rules. For each log rule, static analysis unit 132 may determine whether each log entry meets the log rule one by one, so that the number of log entries meeting a log rule in the source code, that is, second data, can be determined.

As an example, computing device 130 may extract log entries in the function of the source code, and determine the number of a group of log entries including key-value pairs (i.e., “Does the log entry use a key-value pair?”) among the extracted log entries as the second number.

In 404, computing device 130 may determine the second score by determining a ratio of the second number to a total number of the log entries in the function of the source code. In this manner, scoring information of the source code may be determined.

After that, returning to FIG. 2, in 206, computing device 130 may determine a third score of the log file at least based on the first score and the second score. In this way, the maturity of the log file may be evaluated by integrating the log file and the related source code, thereby facilitating selection of a log file with higher maturity and availability from a plurality of log files.

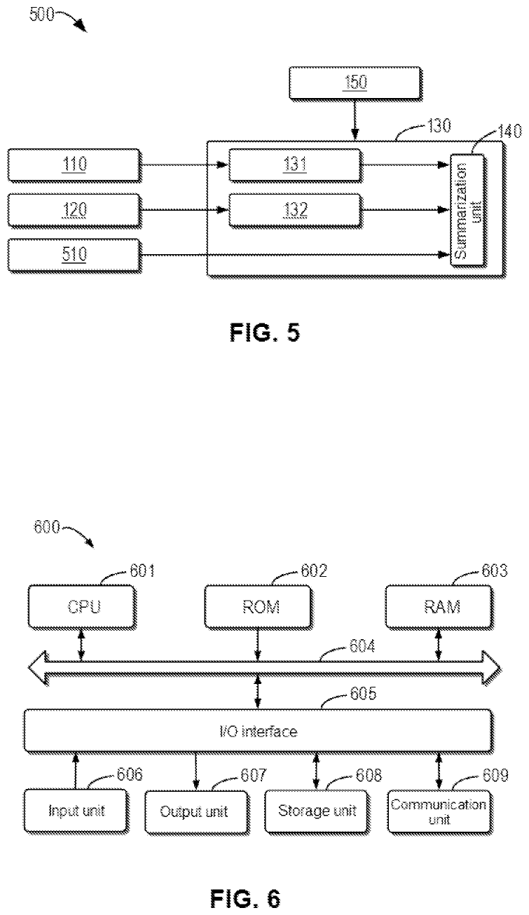

In order to comprehensively consider the scoring of the log file, scoring of the text information by a user may be further added. FIG. 5 is a schematic diagram of another example environment 500 containing a manual scoring mechanism according to one or more embodiments of the present disclosure. FIG. 5 is similar to FIG. 1A, and differs in that document acquisition unit 510 is further added to example environment 100 of FIG. 1A. Moreover, a score of the user from document acquisition unit 510 may be directly summarized to summarization unit 140. In some embodiments, if computing device 130 determines that the score of the log file is higher than a threshold score, the log file can be used to train a natural language processing model and other models.

In some embodiments, based on a group of log entries, the computing device may determine at least one first performance metric for representing the group of log entries, and the at least one first performance metric indicates at least one of the following: analyzability, maintainability, security, and supportability.

FIG. 6 is a schematic block diagram of example electronic device 600 that may be configured to implement to one or more embodiments of the present disclosure. For example, electronic device 600 may be configured to implement computing device 130 as shown in FIG. 1A. As shown in the drawing, electronic device 600 includes central processing unit (CPU) 601 that may perform various appropriate actions and processing according to computer program instructions stored in read-only memory (ROM) 602 or computer program instructions loaded from storage unit 608 into random access memory (RAM) 603. In RAM 603, various programs and data required for operations of device 600 may also be stored. CPU 601, ROM 602, and RAM 603 are connected to each other through bus 604. Input/output (I/O) interface 605 is also connected to bus 604.

Multiple components in device 600 are connected to I/O interface 605, including: input unit 606, such as a keyboard and a mouse; output unit 607, such as various types of displays and speakers; storage unit 608, such as a magnetic disk and an optical disc; and communication unit 609, such as a network card, a modem, and a wireless communication transceiver. Communication unit 609 allows device 600 to exchange information/data with other devices over a computer network such as an Internet and/or various telecommunication networks.

Processing unit 601 performs the various methods and processing described above, such as processes 200, 300, and 400. For example, in some embodiments, the various methods and processing described above may be implemented as a computer software program or a computer program product, which is tangibly included in a machine-readable medium, such as storage unit 608. In some embodiments, part or all of the computer program may be loaded and/or installed onto device 600 via ROM 602 and/or communication unit 609. When the computer program is loaded into RAM 603 and executed by CPU 601, one or more steps of any process described above may be implemented. Alternatively, in other embodiments, CPU 601 may be configured in any other suitable manners (for example, by means of firmware) to perform a process such as processes 200, 300, and 400.

The present disclosure may be a method, an apparatus, a system, and/or a computer program product. The computer program product may include a computer-readable storage medium on which computer-readable program instructions for performing various aspects of the present disclosure are loaded.

The computer-readable storage medium may be a tangible device capable of retaining and storing instructions used by an instruction-executing device. For example, the computer-readable storage medium may be, but is not limited to, an electric storage device, a magnetic storage device, an optical storage device, an electromagnetic storage device, a semiconductor storage device, any non-transient storage device, or any suitable combination of the foregoing. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any appropriate combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein can be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium in each computing/processing device.

The computer program instructions for executing the operation of the present disclosure may be assembly instructions, instruction set architecture (ISA) instructions, machine instructions, machine-dependent instructions, microcode, firmware instructions, state setting data, or source code or object code written in one programming language or any combination of several programming languages, including an object oriented programming language, such as Smalltalk and C++, and a conventional procedural programming language, such as the “C” language or similar programming languages. The computer-readable program instructions may be executed entirely on a user's computer, partly on a user's computer, as a stand-alone software package, partly on a user's computer and partly on a remote computer, or entirely on a remote computer or a server. In a case where a remote computer is involved, the remote computer may be connected to a user computer through any kind of networks, including a local area network (LAN) or a wide area network (WAN), or can be connected to an external computer (for example, connected through the Internet using an Internet service provider). In some embodiments, an electronic circuit, such as a programmable logic circuit, a field programmable gate array (FPGA), or a programmable logic array (PLA), may be customized by utilizing status information of the computer-readable program instructions. The electronic circuit may execute the computer-readable program instructions to implement various aspects of the present disclosure.

Various aspects of the present disclosure are described here with reference to flowcharts and/or block diagrams of the method, the apparatus (system), and the computer program product implemented according to the embodiments of the present disclosure. It should be understood that each block of the flowcharts and/or block diagrams and combinations of blocks in the flowcharts and/or block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or more blocks in the flowcharts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flowcharts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or more blocks in the flowcharts and/or block diagrams.

The flowcharts and block diagrams in the drawings illustrate the architectures, functions, and operations of possible implementations of the systems, methods, and computer program products according to various embodiments of the present disclosure. In this regard, each block in the flowcharts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in an inverse order, which depends on involved functions. It should be further noted that each block in the block diagrams and/or flowcharts as well as a combination of blocks in the block diagrams and/or flowcharts may be implemented using a dedicated hardware-based system that executes specified functions or actions, or using a combination of special hardware and computer instructions.

Various implementations of the present disclosure have been described above. The foregoing description is illustrative rather than exhaustive, and is not limited to the disclosed implementations. Numerous modifications and alterations are apparent to persons of ordinary skill in the art without departing from the scope and spirit of the illustrated implementations. The selection of terms used herein is intended to best explain the principles and practical applications of the implementations or the improvements to technologies on the market, or to enable other persons of ordinary skill in the art to understand the implementations disclosed herein.

1. A method for determining a score of a log file, comprising:
acquiring a log file related to a monitored system and source code corresponding to the log file;
determining a first score of the log file based on a first log rule subset in a log rule set, wherein the log rule set is used to evaluate at least one of analyzability of the log file and supportability of the monitored system;
determining a second score of the source code based on a second log rule subset in the log rule set; and
determining a third score of the log file at least based on the first score and the second score.

2. The method according to claim 1, wherein determining the first score comprises:
determining, from log entries of the log file, a first number of log entries meeting a log rule in the first log rule subset; and
determining the first score by determining a ratio of the first number to a total number of the log entries in the log file.

3. The method according to claim 2, wherein determining the first number comprises:
extracting timestamps of the log entries in the log file; and
determining a number of a group of timestamps meeting a predetermined time accuracy requirement among the extracted timestamps as the first number.

4. The method according to claim 1, wherein determining the second score comprises:
determining, from a function of the source code, a second number of log entries meeting a log rule in the second log rule subset; and
determining the second score by determining a ratio of the second number to a total number of log entries in the function of the source code.

5. The method according to claim 4, wherein determining the second number comprises:
extracting the log entries in the function of the source code; and
determining a number of a group of log entries comprising key-value pairs among the extracted log entries as the second number.

6. The method according to claim 1, further comprising:
if it is determined that the score of the log file is higher than a threshold score, using the log file to train a natural language processing model.

7. An electronic device, comprising:
a processor; and
a memory coupled to the processor and having instructions stored therein, wherein the instructions, when executed by the processor, cause the electronic device to perform actions comprising:
acquiring a log file related to a monitored system and source code corresponding to the log file;
determining a first score of the log file based on a first log rule subset in a log rule set, wherein the log rule set is used to evaluate at least one of analyzability of the log file and supportability of the monitored system;
determining a second score of the source code based on a second log rule subset in the log rule set; and
determining a third score of the log file at least based on the first score and the second score.

8. The electronic device according to claim 7, wherein determining the first score comprises:
determining, from log entries of the log file, a first number of log entries meeting a log rule in the first log rule subset; and
determining the first score by determining a ratio of the first number to a total number of the log entries in the log file.

9. The electronic device according to claim 8, wherein determining the first number comprises:
extracting timestamps of the log entries in the log file; and
determining a number of a group of timestamps meeting a predetermined time accuracy requirement among the extracted timestamps as the first number.

10. The electronic device according to claim 7, wherein determining the second score comprises:
determining, from a function of the source code, a second number of log entries meeting a log rule in the second log rule subset; and
determining the second score by determining a ratio of the second number to a total number of log entries in the function of the source code.

11. The electronic device according to claim 10, wherein determining the second number comprises:
extracting the log entries in the function of the source code; and
determining a number of a group of log entries comprising key-value pairs among the extracted log entries as the second number.

12. The electronic device according to claim 7, wherein the actions further comprise:
if it is determined that the score of the log file is higher than a threshold score, using the log file to train a natural language processing model.

13. A non-transitory computer-readable medium comprising computer readable program code, which when executed by a computer processor, enables the computer processor to:
acquire a log file related to a monitored system and source code corresponding to the log file;
determine a first score of the log file based on a first log rule subset in a log rule set, wherein the log rule set is used to evaluate at least one of analyzability of the log file and supportability of the monitored system;
determine a second score of the source code based on a second log rule subset in the log rule set; and
determine a third score of the log file at least based on the first score and the second score.

14. The computer-readable medium according to claim 13, wherein determining the first score comprises:
determining, from log entries of the log file, a first number of log entries meeting a log rule in the first log rule subset; and
determining the first score by determining a ratio of the first number to a total number of the log entries in the log file.

15. The computer-readable medium according to claim 14, wherein determining the first number comprises:
extracting timestamps of the log entries in the log file; and
determining a number of a group of timestamps meeting a predetermined time accuracy requirement among the extracted timestamps as the first number.

16. The computer-readable medium according to claim 13, wherein determining the second score comprises:
determining, from a function of the source code, a second number of log entries meeting a log rule in the second log rule subset; and
determining the second score by determining a ratio of the second number to a total number of log entries in the function of the source code.

17. The computer-readable medium according to claim 16, wherein determining the second number comprises:
extracting the log entries in the function of the source code; and
determining a number of a group of log entries comprising key-value pairs among the extracted log entries as the second number.

18. The computer-readable medium according to claim 13, further comprising:
if it is determined that the score of the log file is higher than a threshold score, use the log file to train a natural language processing model.
